(19) United States
(12) Patent Application Publication
(10) Pub. No.: US 2014/0016042 A1
(43) Pub. Date: Jan. 16, 2014

(54) SCREEN AND IMAGE DISPLAY SYSTEM

(71) Applicant: Seiko Epson Corporation, Tokyo (JP)

(72) Inventor: Taisuke Yamauchi, Matsumoto (JP)

(21) Appl. No.: 13/934,352

(22) Filed: Jul. 3, 2013

(30) Foreign Application Priority Data
Jul. 12, 2012 (JP) 2012/156274

(51) Int. Cl. G02F 1/139; G02F 1/13

(52) U.S. Cl. CPC G02F 1/139; G02F 1/1313
USPC 349/5; 349/33

(57) ABSTRACT

A screen including a polymer dispersed liquid crystal layer including liquid crystal molecules and polymers different from the liquid crystal molecules, wherein a twist angle of the polymers is equal to or larger than 0° and smaller than 180°, and, when an electric field does not act on the polymer dispersed liquid crystal layer, the polymer dispersed liquid crystal layer changes to a first state in which the polymer dispersed liquid crystal layer transmits light made incident on the polymer dispersed liquid crystal layer and, when an electric filed acts on the polymer dispersed liquid crystal layer, the polymer dispersed liquid crystal layer changes to a second state in which the polymer dispersed liquid crystal layer scatters light made incident on the polymer dispersed liquid crystal layer.

### BACKGROUND

1. Technical Field

The present invention relates to a screen for video display and an image display system including the screen.

2. Related Art

In recent years, as a screen for displaying an image, a screen employing polymer dispersed liquid crystal (PDLC) in which liquid crystal is dispersed in polymers attracts attention (e.g., WO 04/021079 (Patent Literature 1)). Such a display element makes use of a difference between refractive indexes of the liquid crystal and the polymers. For example, the screen changes to a transmission state when an electric field is not applied and changes to a scattering state when an electric field is applied. When the screen changes to the scattering state, a video light is projected on the screen by a projector or the like, whereby a desired image is displayed on the screen.

However, in the screen described in WO 04/021079, a method of controlling a light scattering characteristic that affects brightness and a viewing angle characteristic is unknown. For example, the brightness of an image displayed on a liquid crystal display element is low or there is no method of controlling the viewing angle characteristic.

Concerning the viewing angle characteristic, when an environment is assumed in which such a display apparatus (screen) is used for displaying personal information and used in a public place where an unspecified large number of people gather, if displayed content is viewed from all directions, the personal information leaks to the people around the screen. Therefore, there is a problem in terms of safety of information management.

In a use such as a large display apparatus (screen) for electronic advertisements set in a station premise, a viewing angle from the up down direction is rarely required. It is possible to improve efficiency for light utilization by improving a viewing angle characteristic in the left right direction as much as possible. Therefore, when light scatters in all directions, there is a problem in terms of the efficiency of light utilization.

### SUMMARY

An advantage of some aspects of the invention is to solve at least a part of the problems described above. By controlling a light scattering characteristic, a screen and an image display system that can exhibit excellent display characteristics (particularly brightness and viewing angle) can be implemented as the following forms or application examples.

### Application Example 1

This application example is directed to a screen including a polymer dispersed liquid crystal layer including liquid crystal molecules and polymers different from the liquid crystal molecules. A twist angle of the polymers is equal to or larger than 0° and smaller than 180°. When an electric field does not act on the polymer dispersed liquid crystal layer, the polymer dispersed liquid crystal layer changes to a first state in which the polymer dispersed liquid crystal layer transmits light made incident on the polymer dispersed liquid crystal layer and, when an electric filed acts on the polymer dispersed liquid crystal layer, the polymer dispersed liquid crystal layer changes to a second state in which the polymer dispersed liquid crystal layer scatters light made incident on the polymer dispersed liquid crystal layer.

According to this application example, a twist angle θ of the polymers in the polymer dispersed liquid crystal layer is equal to or larger than 0° and smaller than 180°. Therefore, for example, when the polymers are oriented along an orientation direction and a screen is in the second state, the polymers exhibit a function similar to a function of a diffraction grating in the same direction as the orientation direction. The polymers show intense scattering in plan view of the screen. Consequently, the screen that can exhibit an excellent viewing angle characteristic is obtained.

### Application Example 2

In the screen described in the abovementioned application example, it is preferable that the twist angle of the polymers is 0°.

According to this application example, the twist angle θ of the polymers in the polymer dispersed liquid crystal layer is set to 0°. Therefore, the polymers do not twist in the polymer dispersed liquid crystal layer. When the screen is in a scattering state, the polymers show extremely intense scattering in plan view. Consequently, the screen that can exhibit a more excellent viewing angle characteristic is obtained.

### Application Example 3

In the screen described in the abovementioned application examples, it is preferable that the polymer dispersed liquid crystal layer has anisotropy of scattering intensity of light made incident on the polymer dispersed liquid crystal layer in the second state, and the scattering intensity of the light in a lateral direction of the screen is larger than the scattering intensity of the light in a longitudinal direction.

According to this application example, the screen has anisotropy and the scattering intensity of the light in the lateral direction is larger than the scattering intensity of the light in the longitudinal direction. Consequently, it is possible to increase brightness and a viewing angle in the lateral direction of the screen and observe, from a wide range in the lateral direction of the screen, a bright image displayed on the screen.

### Application Example 4

In the screen described in the abovementioned application examples, it is preferable that the twist angle is represented by α (α satisfies a condition 0≦α<180), and a predetermined angle direction included in the twist angle α coincides with the longitudinal direction of the screen.

### Application Example 5

In the screen described in the abovementioned application examples, it is preferable that a line segment bisecting the angle α coincides with the longitudinal direction of the screen.

### Application Example 6

In the screen described in the abovementioned application examples, it is preferable that the polymer dispersed liquid crystal layer has anisotropy of scattering intensity of light made incident on the polymer dispersed liquid crystal layer in the second state, and the scattering intensity of the light in a longitudinal direction of the screen is larger than the scattering intensity of the light in a lateral direction.

### Application Example 7

In the screen described in the abovementioned application examples, it is preferable that the twist angle is represented by α (α satisfies a condition 0≦α<180), and a predetermined angle direction included in the twist angle α coincides with the lateral direction of the screen.

### Application Example 8

In the screen described in the abovementioned application examples, it is preferable that a line segment bisecting the angle α coincides with the lateral direction of the screen.

### Application Example 9

This application example is directed to an image display system including: the screen described in the abovementioned application examples; a projector configured to project an image on the screen; and a control unit configured to control driving of the screen and the projector.

### BRIEF DESCRIPTION OF THE DRAWINGS

The invention will be described with reference to the accompanying drawings, wherein like numbers reference like elements.

FIG. 1 is a sectional view of a screen according to a first embodiment.

FIG. 2 is a plan view showing a twist structure of a polymer included in the screen according to the first embodiment.

FIG. 3 is a diagram showing a light scattering characteristic of the screen according to the first embodiment.

FIG. 4 is a plan view showing a twist structure of a polymer having a twist angle of 180°.

FIG. 5 is a diagram showing a light scattering characteristic of the polymer having the twist angle of 180°.

FIG. 6 is a schematic configuration diagram of an image display system to which the screen according to the first embodiment is applied.

FIG. 7 is a schematic configuration diagram showing the configuration of a projector according to the first embodiment.

FIG. 8 is a sectional view of a screen according to a second embodiment.

FIG. 9 is a plan view showing a twist structure of a polymer included in the screen according to the second embodiment.

FIG. 10 is a graph showing a light scattering characteristic of the screen according to the second embodiment.

FIG. 11 is a plan view showing a relation between longitudinal and lateral directions and an orientation direction of the polymer of the screen according to the second embodiment.

FIG. 12 is a sectional view of a screen according to a third embodiment.

FIG. 13 is a plan view showing a twist structure of a polymer included in the screen according to the third embodiment.

FIG. 14 is a graph showing a light scattering characteristic of the screen according to the third embodiment.

FIG. 15 is a plan view showing a relation between longitudinal and lateral directions and an orientation direction of the polymer of the screen according to the third embodiment.

### DESCRIPTION OF EXEMPLARY EMBODIMENTS

Preferred embodiments of a screen and an image display system according to the invention are explained in detail below with reference to the drawings.

### First Embodiment

### 1. Screen

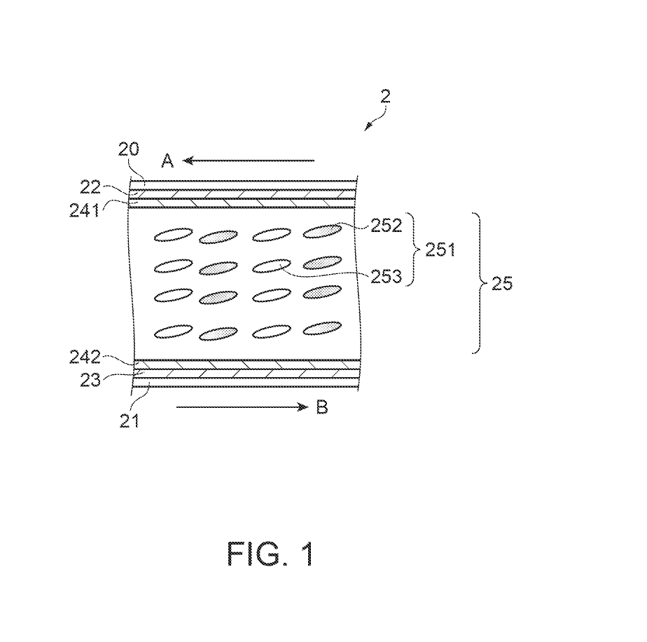

FIG. 1 is a sectional view of a screen according to a first embodiment of the invention. As shown in FIG. 1, a screen 2 includes a pair of transparent substrates 20 and 21, a pair of transparent electrodes 22 and 23, a pair of orientation films 241 and 242, a polymer dispersed liquid crystal layer 25 provided between the pair of transparent substrates 20 and 21, and a not-shown sealing section (a seal material) configured to seal a space between the pair of transparent substrates 20 and 21. The sealing section functions as a spacer that forms an air gap (a space) for forming the polymer dispersed liquid crystal layer 25 between the pair of transparent substrates 20 and 21.

The transparent substrates 20 and 21 have a function of supporting the transparent electrodes 22 and 23 and the orientation films 241 and 242. A material forming the transparent substrates 20 and 21 is not specifically limited. Examples of the material include glass such as quartz glass and a plastic material such as polyethylene-terephthalate. The transparent substrates 20 and 21 are desirably formed of, in particular, the glass such as quartz glass among these materials. Consequently, it is possible to obtain the screen 2 more excellent in stability in which a warp, a bend, and the like less easily occur.

The transparent electrode 22 of the pair of transparent electrodes 22 and 23 is formed on the lower surface (a surface on the transparent substrate 21 side) of the transparent substrate 20. The transparent electrode 23 is formed on the upper surface (a surface on the transparent substrate 20 side) of the transparent substrate 21. The transparent electrodes 22 and 23 have electric conductivity. The transparent electrodes 22 and 23 are formed of, for example, indium tin oxide (ITO), indium oxide (IO), tin oxide (SnO₂), or the like.

The orientation film 241 of the pair of orientation films 241 and 242 is formed on the lower surface (a surface on the transparent substrate 21 side) of the transparent electrode 22. The orientation film 242 is formed on the upper surface (a surface on the transparent substrate 20 side) of the transparent electrode 23. The orientation films 241 and 242 are formed by applying orientation processing such as rubbing processing to a film formed of polyimide, polyvinyl alcohol, or the like.

The polymer dispersed liquid crystal layer 25 includes PDLC (polymer dispersed liquid crystal) 251. A transmission state (a first state) and a scattering state (a second state) of the polymer dispersed liquid crystal layer 25 can be switched according to the intensity of an applied electric field.

The PDLC 251 includes liquid crystal molecules 253 and polymers 252 different from the liquid crystal molecules 253. For example, the PDLC 251 can be formed of, for example, a mixture of a polymeric precursor such as a liquid crystal monomer and liquid crystal molecules. To form the PDLC 251, in a state in which the mixture is oriented by the orientation films 241 and 242, the mixture is irradiated with energy of an ultraviolet ray or the like to polymerize the liquid crystal monomer. Then, while retaining orientation, the liquid crystal monomers are polymerized to change to the polymers 252 having an anchoring force. The liquid crystal molecules 253 are phase-separated from the polymers 252 and oriented by the anchoring force of the polymers 252.

The polymeric precursor only has to dissolve in the liquid crystal molecules 253. Mixed liquid of the polymeric precursor and the liquid crystal molecules 253 only has to have liquid-crystallinity. Examples of the polymeric precursor include a polymeric precursor in which a benzene backbone, preferably, biphenyl backbone is introduced in polymers. Even if not including the benzene backbone, polymers orientated together with the liquid crystal molecules 253 can be used in the same manner.

Specific examples of the polymers 252 and the polymeric precursor include methacrylic acid ester of biphenyl methanol or naphthol, acrylic acid ester, or derivatives of these esters. Methacrylic acid ester of biphenol or an acrylic acid ester derivative may be mixed in the methacrylic acid ester of biphenyl methanol or naphthol, the acrylic acid ester, and the derivative thereof and used. As other examples, α-methyl styrene, epoxy resin, and the like can also be used.

On the other hand, the liquid crystal molecules 253 only have to have refractive index anisotropy and dielectric anisotropy. For example, nematic liquid crystal can be used.

The PDLC 251 in this embodiment is a so-called “reverse type”. Therefore, in a voltage unapplied state in which a voltage is not applied between the pair of transparent electrodes 22 and 23 (an electric field un-generated state in which an electric filed does not act on the polymer dispersed liquid crystal layer 25), the polymer dispersed liquid crystal layer 25 changes to the transmission state in which the polymer dispersed liquid crystal layer 25 has transparency. In a voltage applied state in which a voltage is applied between the pair of transparent electrodes 22 and 23 (an electric field generated state in which an electric field acts on the polymer dispersed liquid crystal layer 25), the polymer dispersed liquid crystal layer 25 changes to the scattering state in which the polymer dispersed liquid crystal layer 25 has duffusibility.

More specifically, in the voltage unapplied state, a refractive index is continuous between the liquid crystal molecules 253 and the polymers 252. Light made incident on the PDLC 251 is emitted without being substantially dispersed and the polymer dispersed liquid crystal layer 25 changes to the transmission state. Conversely, in the voltage applied state, whereas an azimuth angle of the polymers 252 does not change, an azimuth angle of the liquid crystal molecules 253 changes according to an electric field. Consequently, a refractive index discontinuously changes between the polymers 252 and the liquid crystal molecules 253, whereby the incident light is scattered and emitted and the polymer dispersed liquid crystal layer 25 changes to the light scattering state.

The “electric field un-generated state” includes not only a state in which an electric field does not act on the polymer dispersed liquid crystal layer 25 but also a state in which a voltage weaker than a voltage applied in the electric field generated state is applied between the pair of transparent electrodes 22 and 23 and an electric field having small intensity compared with that in the electric field generated state is generated.

With the screen 2 having such a configuration, when the screen 2 is not used, the screen 2 can be made transparent by setting the screen 2 in the transmission state. Therefore, for example, when the screen 2 is used in a living space, it is possible to reduce a feeling of oppression caused by the screen 2. The screen 2 includes the reverse-type PDLC 251. Therefore, it is desirable to use the screen 2 for a use in which time for displaying an image on the screen 2 (time of the scattering state) is shorter than time for not displaying an image on the screen 2 (time of the transmission state). Consequently, it is possible to perform power-saving driving of the screen 2. The basic configuration of the screen 2 is explained above.

A twist angle of the polymers 252 in the polymer dispersed liquid crystal layer, which is a characteristic of the invention, is explained in detail.

In this embodiment, in the polymer dispersed liquid crystal layer 25 formed in the screen 2, on the transparent substrate 20 side, the polymers 252 and the liquid crystal molecules 253 are oriented along an orientation direction A of the orientation film 241. On the transparent substrate 21 side, the polymers 252 and the liquid crystal molecules 253 are oriented along an orientation direction B of the orientation film 242. In the screen 2, orientation directions of the orientation films 241 and 242 are different from each other. The screen 2 is formed in a structure in which, from the transparent substrate 20 side to the transparent substrate 21 side, the orientation directions of the polymers 252 and the liquid crystal molecules 253 are aligned at a specific tilt angle without twisting. Rotating directions of the orientation directions are not specifically limited. The orientation directions may rotate clockwise or may rotate counterclockwise.

The screen according to the embodiment of the invention is characterized in that a twist angle θ of the polymers in the polymer dispersed liquid crystal layer is equal to or larger than 0° and smaller than 180°. Since the screen has such a characteristic, as explained below, the screen that can exhibit an excellent viewing angle characteristic is obtained.

In particular, in the screen 2 according to this embodiment, the twist angle θ of the polymers 252 in the polymer dispersed liquid crystal layer 25 is set to 0°. Since the twist angle θ is set in this way, it is possible to realize the screen having a viewing angle only in a specific angle direction. A reason for this is explained in detail below.

The polymers 252 in the polymer dispersed liquid crystal layer 25 are oriented along the orientation direction A of the orientation film 241 on the transparent substrate 20 side. Therefore, when the screen 2 is in the scattering state, the polymers 252 exhibit the same function as a function of a diffraction grating in the same direction as an orientation axis (the orientation direction A) of the orientation film 241 on the transparent substrate 20 side. In plan view of the screen 2, the polymers 252 show more intense scattering in a direction orthogonal to the orientation direction A. The polymers 252 do not twist in the polymer dispersed liquid crystal layer 25 because the orientation is 0°. Consequently, the polymers 252 show extremely intense scattering in the direction orthogonal to the orientation direction A.

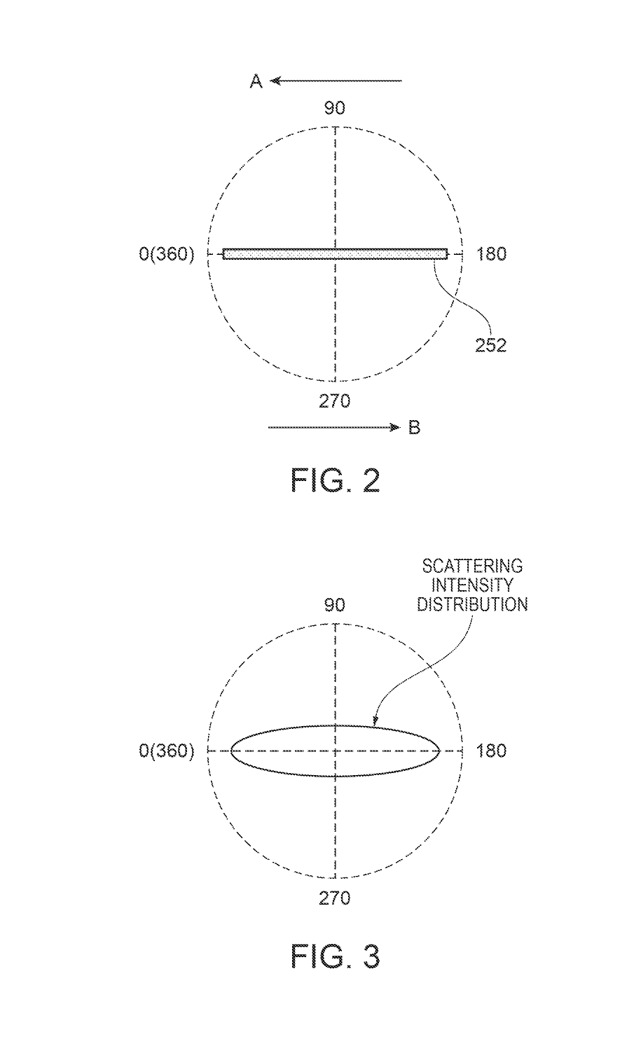

FIG. 2 is a schematic plan view showing a twist structure of the polymer 252 in the screen 2 viewed from the transparent substrate 20 side. FIG. 3 is a graph showing a light scattering characteristic of the screen 2. The light scattering characteristic shown in the graph of FIG. 3 is data obtained by irradiating a parallel beam (visible light) on the transparent substrate 20 from a normal direction with respect to the surface of the transparent substrate 20 and measuring transmitted scattered light in a position on the normal of the transparent substrate 21. 0 (360), 90, 180, and 270 described on the outer side of the graph indicate azimuth angles φ of incident light. A relation between the azimuth angles and the light scattering characteristic directly indicates the viewing angle characteristic of the screen 2.

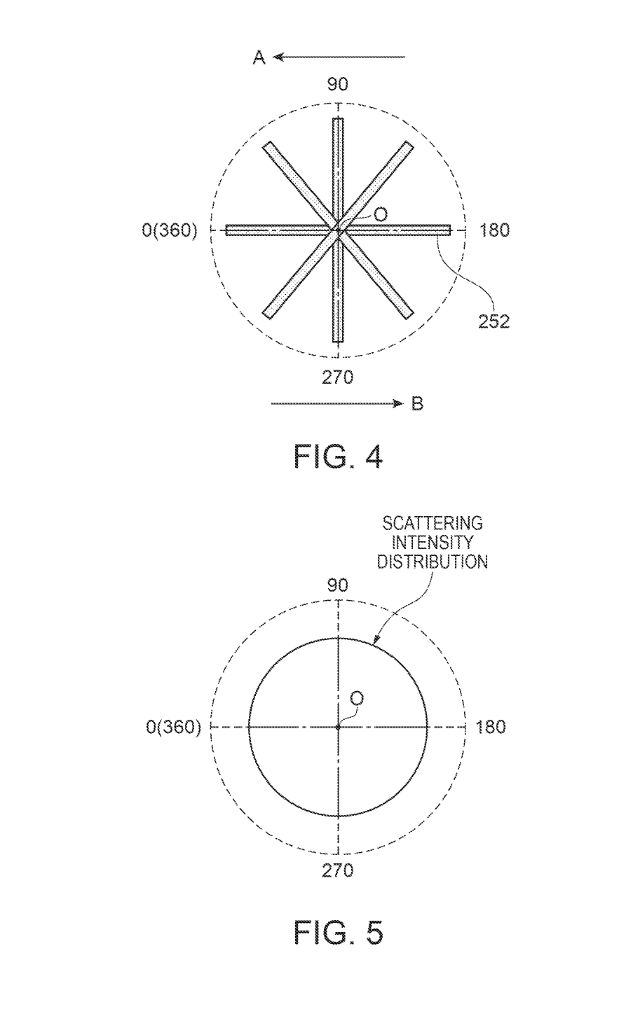

On the other hand, as shown in FIG. 4, when the twist angle of the polymer 252 is 180°, orientation axes of the polymer 252 are uniformly present in all angle directions from a twist center O of the polymer 252. Therefore, as shown in FIG. 5, the polymer 252 shows uniform high scattering intensity in all the angle directions from the twist center O. In other words, the polymer 252 shows a luminous intensity distribution not depending on a viewing angle in all the angle directions. Therefore, the screen has viewing angles in all the angle directions. In the screen having such a viewing angle characteristic, the viewing angle characteristic is undesirable when information including personal information is displayed, for example, in a public place where an unspecified large number of people come and go. In a use such as a large display apparatus for electronic advertisements set in a station premise, a viewing angle from the up down direction is rarely required. Efficiency of light utilization can be improved by improving a viewing angle characteristic in the left right direction as much as possible. Therefore, when light scatters in all directions, the viewing angle characteristic is undesirable in terms of the efficiency of light utilization.

### 2. Image Display System

An image display system 100 to which the screen 2 is applied is explained.

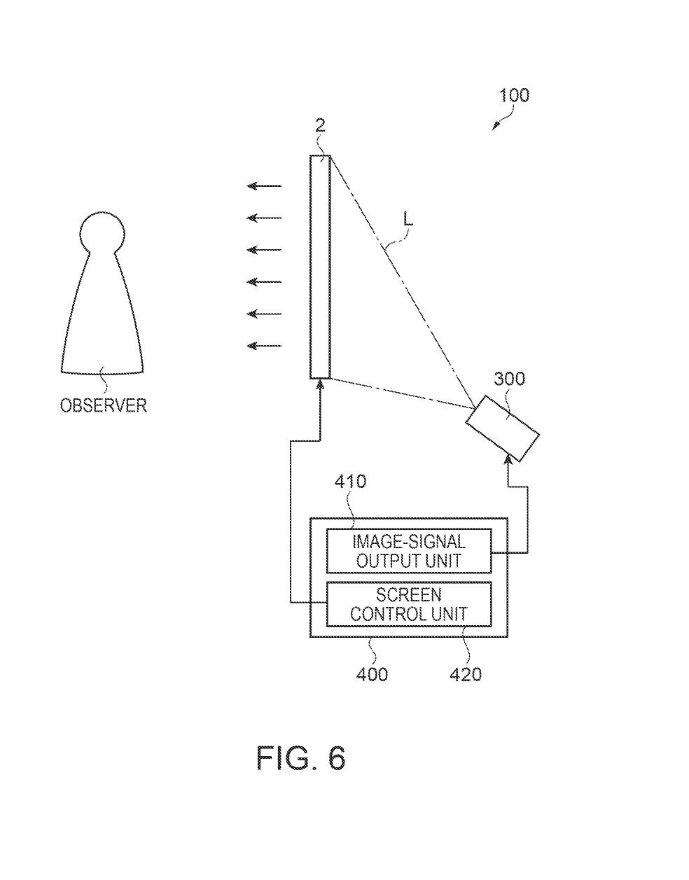

As shown in FIG. 6, the image display system 100 includes the screen 2, a projector 300 configured to project an image on the screen 2, and a control unit 400 configured to control driving of the screen 2 and the projector 300. In the image display system 100, an image is projected on the rear surface (a surface on the opposite side of an observer) of the screen 2. An image may be projected on the front surface (a surface on the observer side) of the screen 2.

The projector 300 is not specifically limited as long as the projector 300 can display an image on the screen 2. The projector 300 may be a projector of an illumination projection type that enlarges and projects image light on the screen 2 by irradiating a micro imager such as a liquid crystal panel with light or a projector of a scanning type that scans light on the screen 2 and forms an image. An example of the projector 300 is explained below.

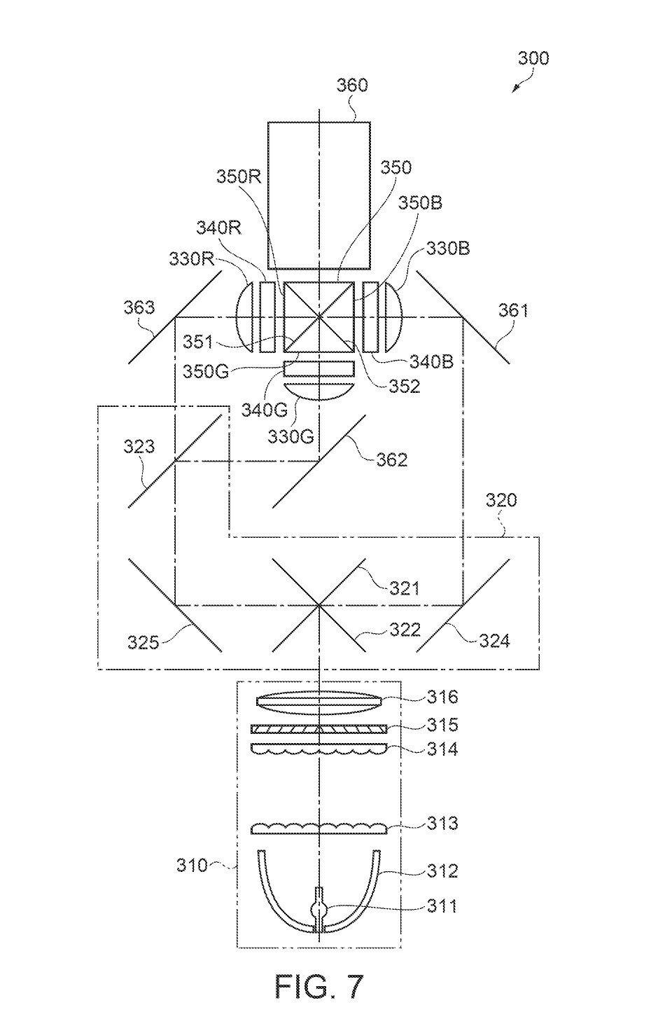

FIG. 7 is a plan view showing the configuration of an optical system of the projector 300. As shown in FIG. 7, the projector 300 includes an illumination optical system 310, a color separation optical system 320, parallelizing lenses 330R, 330G, and 330B, spatial light modulating devices 340R, 340G, and 340B, and a cross-dichroic prism 350, which is alight combining section.

The illumination optical system 310 includes a light source 311, a reflector 312, a first lens array 313, a second lens array 314, a polarization converting element 315, and a superimposing lens 316.

The light source 311 is an extra-high pressure mercury lamp. The reflector 312 includes a parabolic surface mirror. A radial light beam emitted from the light source 311 is reflected by the reflector 312 to change to a substantially parallel light beam and emitted to the first lens array 313. The light source 311 is not limited to the ultra-high pressure mercury lamp. For example, a metal halide lamp may be adopted. The reflector 312 is not limited to the parabolic surface mirror. A configuration in which a parallelizing concave lens is arranged on an emission surface of a reflector including an elliptical surface mirror may be adopted.

The first lens array 313 and the second lens array 314 are formed by arraying small lenses in a matrix shape. A light beam emitted from the light source 311 is divided into a plurality of very small partial light beams by the first leans array 313. The respective partial light beams are superimposed on the surface of the three spatial light modulating devices 340R, 340G, and 340B, which are illumination targets, by the second lens array 314 and the superimposing lens 316.

The polarization converting element 315 has a function of integrating light beams of random polarization as a linearly polarized light (S polarized light or P polarized light) oscillating in one direction. In this embodiment, the polarization converting element 315 integrates the light beams as the S polarized light having little loss of light beams in the color separation optical system 320.

The color separation optical system 320 has a function of separating a light beam (S polarized light) emitted from the illumination optical system 310 into color lights of three colors, i.e., red (R) light, green (G) light, and blue (B) light. The color separation optical system 320 includes a B light reflection dichroic mirror 321, an RG light reflection dichroic mirror 322, a G light reflection dichroic mirror 323, and reflection mirrors 324 and 325.

A component of the B light in the light beam emitted from the illumination optical system 310 is reflected by the B light reflection dichroic mirror 321 and further reflected by the reflection mirror 324 and a reflection mirror 361 to reach the parallelizing lens 330B. Components of the G light and the R light in the light beam emitted from the illumination optical system 310 is reflected by the RG light reflection dichroic mirror 322 and further reflected by the reflection mirror 325 to reach the G light reflection dichroic mirror 323. The component of the G light is reflected by the G light reflection dichroic mirror 323 and the reflection mirror 362 to reach the parallelizing lens 330G. The component of the R light is transmitted through the G light reflection dichroic mirror 323 and reflected by the reflection mirror 363 to reach the parallelizing lens 330R.

The parallelizing lenses 330R, 330G, and 330B are set such that the plurality of partial light beams from the illumination optical system 310 respectively change to parallel light beams to respectively illuminate the spatial light adjusting devices 340R, 340G, and 340B.

The R light transmitted through the parallelizing lens 330R reaches the spatial light modulating device 340R. The G light transmitted through the parallelizing lens 330G reaches the spatial light modulating device 340G. The B light transmitted through the parallelizing lens 330B reaches the spatial light modulating device 340B.

The spatial light modulating device 340R is a spatial light modulating device that modulates the R light according to an image signal and is a transmission liquid crystal display device. In a not-shown liquid crystal panel provided in the spatial light modulating device 340R, a liquid crystal layer for modulating light according to an image signal is encapsulated between two transparent substrates. The R light modulated by the spatial light modulating device 340R is made incident on the cross-dichroic prism 350, which is a color combination optical system. The configuration and the function of the spatial light modulating devices 340G and 340B are the same as the configuration and the function of the spatial light modulating device 340R.

The cross-dichroic prism 350 is formed in a prism shape by bonding four triangular prism-shaped prisms together. Dielectric multilayer films 351 and 352 are provided along an X-shaped bonding surface. The dielectric multilayer film 351 transmits the G light and reflects the R light. The dielectric multilayer film 352 transmits the G light and reflects the B light. The cross-dichroic prism 350 makes modulated lights of the respective color lights, which are emitted from the spatial light modulating devices 340R, 340G, and 340B, respectively incident from incident surfaces 350R 350G, and 350B, combines the lights, forms image light representing a color image, and emits the image light to a projecting optical unit 360.

Consequently, video light L, which is linearly polarized light, is emitted from the projector 300.

As shown in FIG. 6, the control unit 400 includes an image-signal output unit 410 configured to output an image signal to the projector 300 and a screen control unit 420 configured to control driving (ON/OFF) of the screen 2. The projector 300 receives the image signal from the image-signal output unit 410 and emits the video light L based on the image signal.

The control unit 400 is configured to control, with the screen control unit 420, driving of the screen 2 in response to the output of the image signal from the image-signal output unit 410 to the projector 300. Specifically, in a state in which the image-signal output unit 410 is not outputting the image signal, the control unit 400 changes the screen 2 to the transmission state with the screen control unit 420. Conversely, in a state in which the image-signal output unit 410 is outputting the image signal, the control unit 400 changes the screen 2 to the scattering state with the screen control unit 420.

According to such control, when the projector 300 is not emitting the video light L, i.e., when an image to be displayed on the screen 2 is absent, the screen 2 can be changed to the transmission state. When the projector 300 is emitting the video light L, the screen 2 can be changed to the scattering state and an image corresponding to the image light L can be displayed on the screen 2. That is, with simple control, the screen 2 can be made transparent except when an image is displayed on the screen 2. Therefore, it is possible to realize power saving and reduce the feeling of oppression to the living space.

### Second Embodiment

A screen according to a second embodiment of the invention is explained.

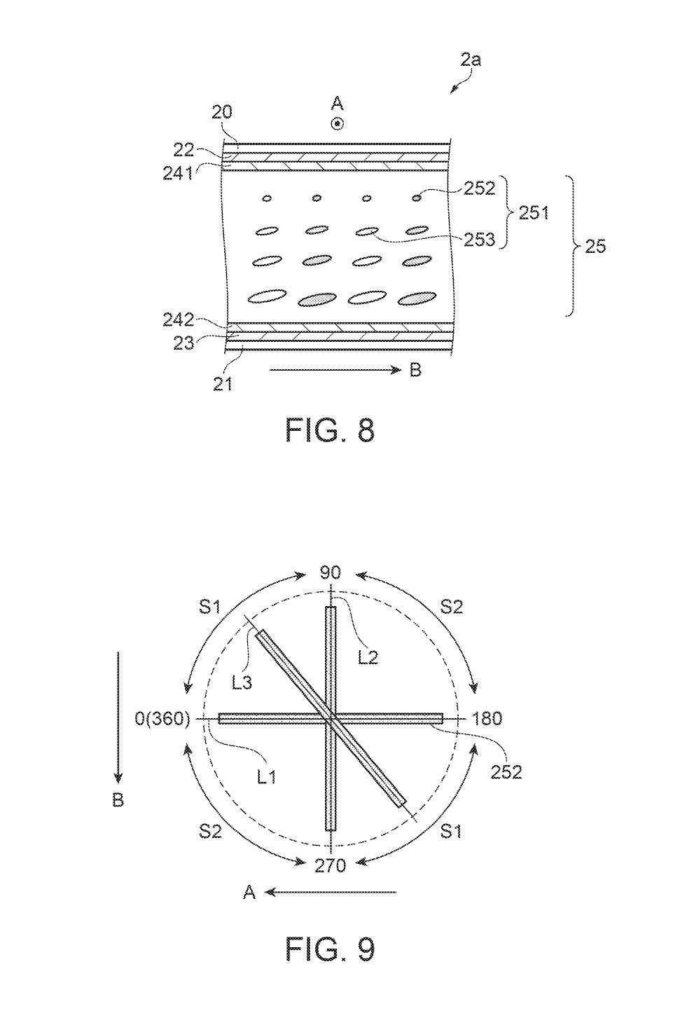

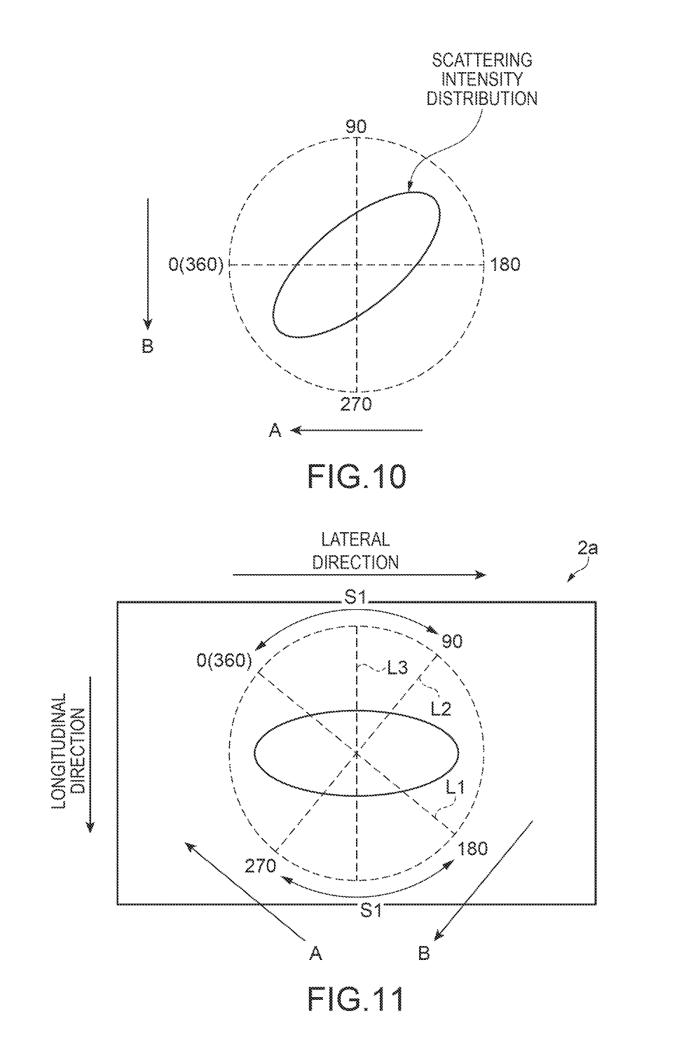

FIG. 8 is a sectional view of the screen according to the second embodiment of the invention. FIG. 9 is a plan view showing a twist structure of a polymer included in the screen shown in FIG. 8. FIG. 10 is a graph showing a light scattering characteristic of the screen shown in FIG. 8. FIG. 11 is a plan view showing a relation between longitudinal and lateral directions and an orientation direction of the polymer of the screen shown in FIG. 8.

Concerning the screen according to the second embodiment, differences from the screen according to the first embodiment are mainly explained below. Explanation of the same matters is omitted.

The screen according to the second embodiment of the invention is the same as the screen according to the first embodiment except that a twist angle of polymers is different. The same components as the components in the first embodiment are denoted by the same reference numerals and signs.

The polymer dispersed liquid crystal layer 25 included in a screen 2a according to this embodiment has anisotropy of light scattering intensity in plan view thereof. The light scattering intensity in the lateral direction of the screen 2a is larger than the light scattering intensity in the longitudinal direction of the screen 2a. Consequently, it is possible to increase brightness and a viewing angle in the lateral direction of the screen 2a and observe, from a wide range in the lateral direction of the screen 2a, a bright image displayed on the screen 2a.

Therefore, the screen 2a according to this embodiment can be suitably used as a screen for allowing a large number of people present in different locations to simultaneously observe an image such as a large screen set at a street corner, a shop, or the like.

The screen 2a according to this embodiment is explained in detail below.

In the screen 2a according to this embodiment, an orientation direction of the polymers 252 and the liquid crystal molecules 253 rotates clockwise from the transparent substrate 20 side to the transparent substrate 21 side. A rotating direction of the orientation direction is not specifically limited. The orientation direction of the polymers 252 and the liquid crystal molecules 253 may rotate counterclockwise.

The twist angle θ of the polymers 252 is an angle equal to or larger than 0° and smaller than 180°. That is, the twist angle θ of the polymers 252 is represented by α° (α° satisfies a relation 0<=α°<180). Examples of the twist angle θ include 0°, 45°, 90°, and 135°.

As shown in FIG. 8, in the screen 2a according to this embodiment, the twist angle θ of the polymer 252 is set to 90°. Consequently, as in the first embodiment, it is possible to show high scattering intensity in a specific angle direction and exhibit an effect explained below.

As shown in FIG. 9, in plan view of the screen 2a, in first regions S1 where an azimuth angle is equal to or larger than 0° and equal to or smaller than 90° and equal to or larger than 180° and equal to or smaller than 270°, a plurality of polymers 252 are present while involving a twist. On the other hand, in second regions S2 where an azimuth angle is larger than 90° and smaller than 180° and larger than 270° and smaller than 360°, the polymers 252 are absent.

In such a state, light scatters in the first regions S1 but does not scatter in the second regions S2. Therefore, light scattering intensity in a direction orthogonal to the first regions S1 is larger than light scattering intensity in a direction orthogonal to the second regions S2. Therefore, as shown in FIG. 10, the screen 2a according to this embodiment has light scattering intensity having anisotropy.

Therefore, in order to increase the brightness and the viewing angle in the lateral direction of the screen 2a, as shown in FIG. 11, the orientation directions A and B of the orientation films 241 and 242 only have to be specified such that the first regions S1, which are regions with high light scattering intensity, are arranged side by side along the longitudinal direction of the screen 2a. That is, the orientation directions A and B of the orientation films 241 and 242 only have to be specified such that a predetermined angle direction included in the angle α°, more specifically, a line segment L1 connecting the azimuth angles 0° and 180°, which are one ends of the respective first regions S1, a line segment L2 connecting the azimuth angles 90° and 270°, which are the other ends of the respective first regions S1, or any one of a large number of line segments L3 present between the line segments L1 and L2 extends along the longitudinal direction of the screen 2a. Consequently, the screen 2a is obtained in which the light scattering intensity in the lateral direction is larger than the light scattering intensity in the longitudinal direction and the brightness and the viewing angle in the lateral direction are high.

Examples of a more desirable arrangement include an arrangement in which the line segment L3 (a segment bisecting the angle α′) connecting 45° and 225°, which are median values (mean values) of azimuth angles included in the respective first regions S1, extends along the longitudinal direction of the screen 2a. Consequently, it is possible to further increase the brightness and the viewing angle in the lateral direction of the screen 2a.

In a use such as a large display apparatus for electronic advertisements set in a station premise, a viewing angle from the up down direction is rarely required. Therefore, it is useful to use such a screen in the large display apparatus because it is possible to increase efficiency of light utilization by increasing a viewing angle characteristic in the left right direction as much as possible.

### Third Embodiment

A screen according to a third embodiment of the invention is explained.

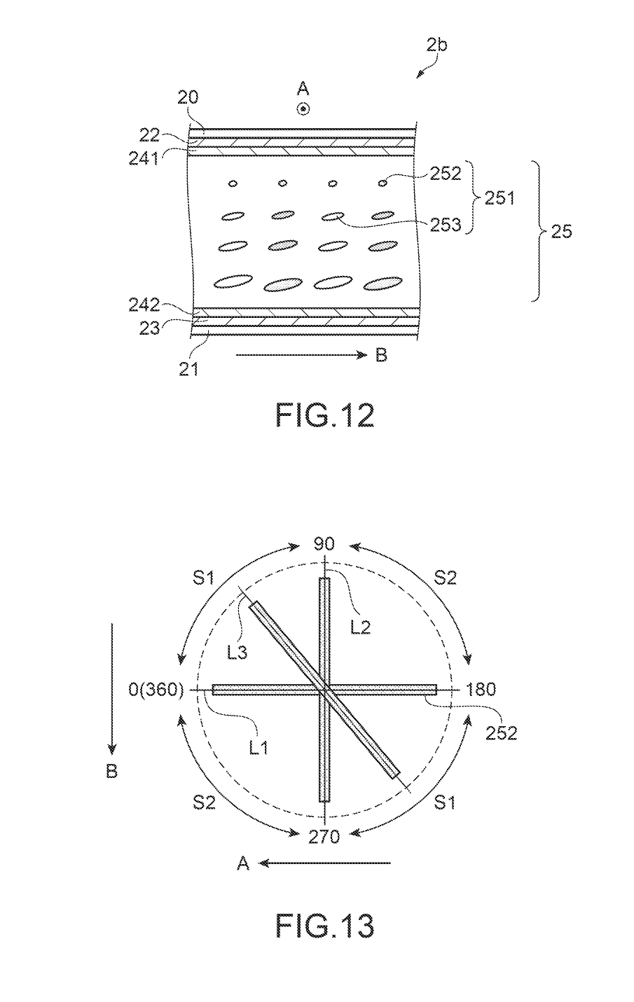

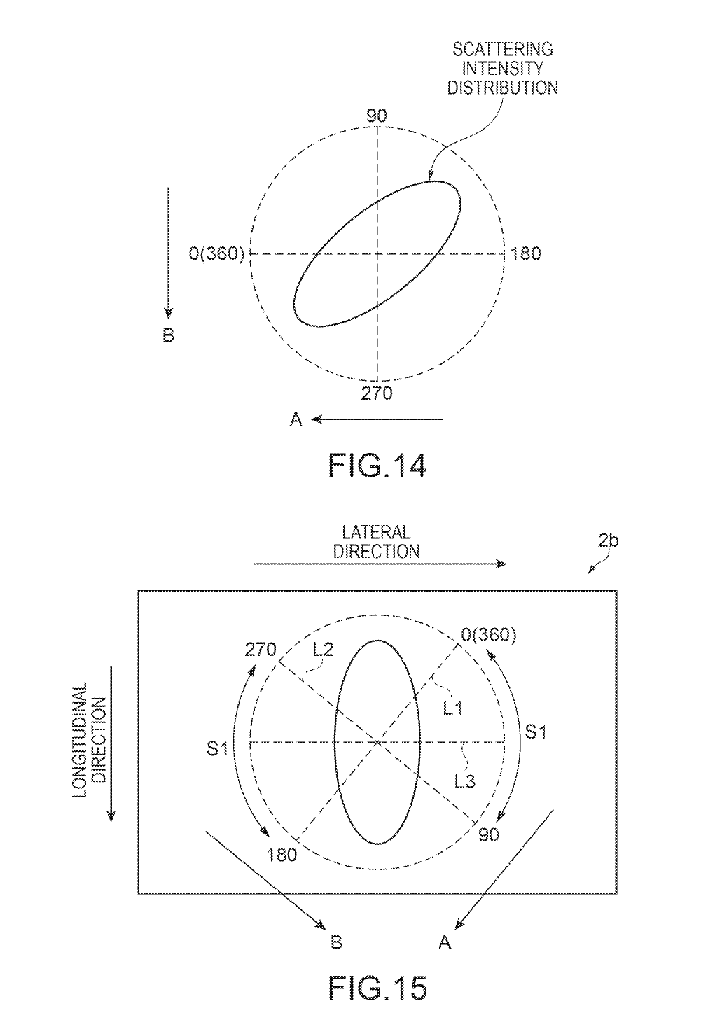

FIG. 12 is a sectional view of the screen according to the third embodiment. FIG. 13 is a plan view showing a twist structure of a polymer included in the screen shown in FIG. 12. FIG. 14 is a graph showing a light scattering characteristic of the screen shown in FIG. 12. FIG. 15 is a plan view showing a relation between longitudinal and lateral directions and an orientation direction of the polymer of the screen shown in FIG. 12.

Concerning the screen according to the third embodiment, differences from the screen according to the embodiments explained above are mainly explained below. Explanation of the same matters is omitted.

The screen according to the third embodiment of the invention is the same as the screen according to the second embodiment except that an orientation direction of orientation films is different. The same components as the components in the second embodiment are denoted by the same reference numerals and signs.

The polymer dispersed liquid crystal layer 25 included in a screen 2b according to this embodiment has anisotropy of light scattering intensity in plan view thereof. The light scattering intensity in the longitudinal direction of the screen 2b is larger than the light scattering intensity in the lateral direction of the screen 2b. Consequently, it is possible to increase brightness and a viewing angle in the longitudinal direction of the screen 2b and observe, from a wide range in the longitudinal direction of the screen 2b, a bright image displayed on the screen 2b.

Therefore, the screen 2b according to this embodiment can be suitably used as a relatively small screen for personal use viewed by one individual such as a photo frame or a monitor for a personal computer.

In the screen 2b for personal use, usually, one observer observes, from the front, an image displayed on the screen 2b. Therefore, a viewing angle in the lateral direction is not important. On the other hand, depending on the height, the posture (sitting or standing), or the like of an observer, the screen 2b and the position of the face (the eyes) of the observer shift in the longitudinal direction. Therefore, it is important that a viewing angle in the longitudinal direction is wide.

For example, when information including personal information is displayed in a public place where an unspecified large number of people come and go, it is important that a viewing angle in the lateral direction is limited. The screen 2b according to this embodiment is explained in detail below.

In the screen 2b according to this embodiment, an orientation direction of the polymers 252 and the liquid crystal molecules 253 rotates clockwise from the transparent substrate 20 side to the transparent substrate 21 side. A rotating direction of the orientation direction is not specifically limited. The orientation direction of the polymers 252 and the liquid crystal molecules 253 may rotate counterclockwise.

The twist angle θ of the polymers 252 is an angle equal to or larger than 0° and smaller than 180°. That is, the twist angle θ of the polymers 252 is represented by α° (α° satisfies a relation 0<=α°<180). Examples of the twist angle θ include 0°, 45°, 90°, and 135°.

As shown in FIG. 12, in the screen 2b according to this embodiment, the twist angle θ of the polymer 252 is set to 90°. Consequently, as in the first and second embodiments, it is possible to show high scattering intensity in a specific angle direction. Further, it is possible to exhibit an effect explained below.

As shown in FIG. 13, in plan view of the screen 2b, in the first regions S1 where an azimuth angle is equal to or larger than 0° and equal to or smaller than 90° and equal to or larger than 180° and equal to or smaller than 270°, the plurality of polymers 252 are present while involving a twist. On the other hand, in the second regions S2 where an azimuth angle is larger than 90° and smaller than 180° and larger than 270° and smaller than 360°, the polymers 252 are absent. In such a state, light scatters in the first regions S1 but does not scatter in the second regions S2. Therefore, light scattering intensity in a direction orthogonal to the first regions S1 is larger than light scattering intensity in a direction orthogonal to the second regions S2. Therefore, as shown in FIG. 14, the screen 2b according to this embodiment has light scattering intensity having anisotropy.

Therefore, in order to increase the brightness and the viewing angle in the longitudinal direction of the screen 2b, as shown in FIG. 15, the orientation directions A and B of the orientation films 241 and 242 only have to be specified such that the first regions S1, which are regions with high light scattering intensity, are arranged side by side along the lateral direction of the screen 2b. That is, the orientation directions A and B of the orientation films 241 and 242 only have to be specified such that a predetermined angle direction included in the angle α°, more specifically, the line segment L1 connecting the azimuth angles 0° and 180°, which are one ends of the respective first regions S1, the line segment L2 connecting the azimuth angles 90° and 270°, which are the other ends of the respective first regions S1, or any one of the large number of line segments L3 present between the line segments L1 and L2 extends along the lateral direction of the screen 2b. Consequently, the screen 2b is obtained in which the light scattering intensity in the longitudinal direction is larger than the light scattering intensity in the lateral direction and the brightness and the viewing angle in the longitudinal direction are high.

Examples of a more desirable arrangement include an arrangement in which the line segment L3 (a segment bisecting the angle α°) connecting 45° and 225°, which are median values (mean values) of azimuth angles included in the respective first regions S1, extends along the lateral direction of the screen 2b. Consequently, it is possible to further increase the brightness and the viewing angle in the longitudinal direction of the screen 2b.

According to the embodiments explained above, the screen is bright and can exhibit a light scattering characteristic having light scattering intensity only in a specific angle direction. Therefore, the screen is excellent in brightness and a viewing angle characteristic.

When an environment is assumed in which such a screen is used for displaying personal information and used in a public place where an unspecified large number of people gather, since displayed content is viewed only from a specific direction, the screen is useful in terms of safety of information management.

The screen and the image display system according to the invention are explained above on the basis of the embodiments shown in the figures. However, the invention is not limited to the embodiments. The components of the units can be replaced with arbitrary components having the same functions.

Other arbitrary components may be added to the invention. For example, the invention can be applied to a screen for a projection image display apparatus, video display apparatuses in a home, an office, and a digital signage, and the like. The embodiments explained above may be combined as appropriate.

The entire disclosure of Japanese Patent Application No. 2012-156274, filed Jul. 12, 2012 is expressly incorporated by reference herein.

What is claimed is:

1. A screen comprising a polymer dispersed liquid crystal layer including liquid crystal molecules and polymers different from the liquid crystal molecules, wherein
a twist angle of the polymers is equal to or larger than 0° and smaller than 180°, and
when an electric field does not act on the polymer dispersed liquid crystal layer, the polymer dispersed liquid crystal layer changes to a first state in which the polymer dispersed liquid crystal layer transmits light made incident on the polymer dispersed liquid crystal layer and, when an electric filed acts on the polymer dispersed liquid crystal layer, the polymer dispersed liquid crystal layer changes to a second state in which the polymer dispersed liquid crystal layer scatters light made incident on the polymer dispersed liquid crystal layer.

2. The screen according to claim 1, wherein the twist angle of the polymers is 0°.

3. The screen according to claim 1, wherein
the polymer dispersed liquid crystal layer has anisotropy of scattering intensity of light made incident on the polymer dispersed liquid crystal layer in the second state, and
the scattering intensity of the light in a lateral direction of the screen is larger than the scattering intensity of the light in a longitudinal direction.

4. The screen according to claim 3, wherein
the twist angle is represented by α (α satisfies a condition 0≦α<180), and
a predetermined angle direction included in the twist angle α coincides with the longitudinal direction of the screen.

5. The screen according to claim 4, wherein a line segment bisecting the angle α coincides with the longitudinal direction of the screen.

6. The screen according to claim 1, wherein
the polymer dispersed liquid crystal layer has anisotropy of scattering intensity of light made incident on the polymer dispersed liquid crystal layer in the second state, and
the scattering intensity of the light in a longitudinal direction of the screen is larger than the scattering intensity of the light in a lateral direction.

7. The screen according to claim 6, wherein
the twist angle is represented by α (α satisfies a condition 0≦α<180), and
a predetermined angle direction included in the twist angle α coincides with the lateral direction of the screen.

8. The screen according to claim 7, wherein a line segment bisecting the angle α coincides with the lateral direction of the screen.

9. An image display system comprising:
the screen according to claim 1;
a projector configured to project an image on the screen; and
a control unit configured to control driving of the screen and the projector.

10. An image display system comprising:
the screen according to claim 2;
a projector configured to project an image on the screen; and
a control unit configured to control driving of the screen and the projector.

11. An image display system comprising:
the screen according to claim 3;
a projector configured to project an image on the screen; and
a control unit configured to control driving of the screen and the projector.

12. An image display system comprising:
the screen according to claim 4;
a projector configured to project an image on the screen; and
a control unit configured to control driving of the screen and the projector.

13. An image display system comprising:
the screen according to claim 5;
a projector configured to project an image on the screen; and
a control unit configured to control driving of the screen and the projector.

14. An image display system comprising:
the screen according to claim 6;
a projector configured to project an image on the screen; and
a control unit configured to control driving of the screen and the projector.

15. An image display system comprising:
the screen according to claim 7;
a projector configured to project an image on the screen; and
a control unit configured to control driving of the screen and the projector.

16. An image display system comprising:
the screen according to claim 8;
a projector configured to project an image on the screen; and
a control unit configured to control driving of the screen and the projector.
